(19) United States
(12) Patent Application Publication
(10) Pub. No.: US 2021/0139166 A1
(43) Pub. Date: May 13, 2021

(54) POSITION DETERMINATION DEVICE, POSITION DETERMINATION SYSTEM PROVIDED WITH THE SAME, AND POSITION DETERMINATION METHOD AND PROGRAM

(71) Applicant: MITSUBISHI HEAVY INDUSTRIES, LTD., Tokyo (JP)

(72) Inventors: Nozomi SAITO, Tokyo (JP); Takashi YARI, Tokyo (JP); Nobuhiro HIGUCHI, Tokyo (JP)

(21) Appl. No.: 16/488,809

(22) PCT Filed: Feb. 22, 2018
(86) PCT No.: PCT/JP2018/006390

§ 371 Date: Aug. 26, 2019

(30) Foreign Application Priority Data
Feb. 27, 2017 (JP) 2017-035026

(51) Int. Cl. B64F 5/60

(52) U.S. Cl. CPC B64F 5/60

(57) ABSTRACT

To detect damages of aircrafts using a small number of sensors. Provided with a category generation unit that categories usage environment information set that is determined based on aircraft types associated with the aircrafts and flight conditions associated with the aircrafts and that indicates usage environments of the airframes of the aircrafts into a plurality of categories in such a way that similar usage environment information set is categorized into the same category; an extraction unit that extracts a category in which an aircraft to be diagnosed is categorized; and a determination unit that determines the arrangement positions of measurement devices relative to the aircraft to be diagnosed, based on previous data that changes for each of the usage environments and that has been obtained when one of the aircrafts has been operated under a usage environment corresponding to the categorized category.

### TECHNICAL FIELD

The present invention relates to a position determination device, a position determination system provided with it, and position determination method and program.

### BACKGROUND ART

Recently, for the purpose of the reduction of maintenance cost for maintaining the structures of aircrafts, the development of structural health monitoring (SHM) techniques and the attempt of applying flight management methods utilizing monitoring data have been active. In the monitoring, there are two kinds of monitoring, one being hotspot monitoring that allows measurements to be made in a state in which measurement devices are arranged at structurally critical portions having been predicted in advance through an analysis and the like, the other one being overall monitoring for the purpose of the detection of at least an unexpected damage. In the overall monitoring, overall structures can be monitored, but, actually, the monitoring of all structural ranges is not realistic because it needs a significantly large amount of work.

Patent Citation 1: Japanese Translation of PCT International Application, Publication No. 2008-505004

### DISCLOSURE OF INVENTION

For the hotspot monitoring, its implementability is high because of its limited monitoring points. In actual operation, damages sometimes occur in portions other than portions having been predicted in advance in an aircraft, and the influence exerted by such an occurrence of damages is large from aspects of cost, schedule, and safety.

In Patent Literature 1, it is disclosed that health monitoring is performed in a state in which a plurality of sensors are arranged in an aircraft, but there have been problems in that, because of the difficulty in predicting the occurrence of damages in advance, the number of the measurement devices exceeds an actually required number, and the measurement devices are not always arranged at preferable damage detection positions.

The present invention has been made in view of such circumstances, and intends to provide a position determination device, a position determination system provided with it, and position determination method and program that are capable of accurately detecting damages of an aircraft, using a worthwhile number of sensors.

In order to solve the above problems, the present invention employs the following means.

The present invention provides a position determination device for determining an arrangement position of a measurement device for structural health measurement values in an aircraft whose structural health status is to be diagnosed, the position determination device comprising: a category generation unit that categorizes in a same category, aircrafts having respective similar usage environment information sets, each usage environment information set being determined based on an aircraft type of the respective aircraft and a flight condition of the respective aircraft and indicating a usage environment of an airframe of the respective aircraft, and categorizes usage environment information sets into a plurality of categories; an extraction unit that extracts among the plurality of categories, a category into which the aircraft to be diagnosed is categorized; and a determination unit that determines the arrangement position of the measurement device relative to the aircraft to be diagnosed, based on previous data that changes depending on the usage environment and that has been obtained when aircrafts has been operated under the usage environment categorized into the category.

According to the above configuration of the present invention, based on the aircraft types of the aircrafts and the flight conditions of the aircrafts, aircrafts having respective similar usage environment information sets, indicating usage environments of the airframes of the respective aircrafts, are categorizing in a same category, usage environment information sets are categorized into a plurality of categories and among the plurality of categories, a category into which the aircraft is categorized is extracted. The arrangement position of the measurement devices relative to the aircraft to be diagnosed is determined based on previous data that has been obtained when the aircrafts has been operated under the usage environment categorized into the category.

In the aircrafts, for each of the usage environments, attention portions of each of airframes (for example, portions likely to be subjected to influences, damaged portions, and/or the like) are similar. The aircraft to be diagnosed is categorized into a category in which the usage environment information set is similar, and the arrangement portion of the measurement device is determined based on previous data having been obtained under a usage environment corresponding to the categorized category. In this way, it is enough just to determine the arrangement position in such a way that, based on the category, a portion at which influences, damaged portions, or the like have occurred is set as a monitoring target, and thus, the measurement devices are reduced, and the probability of the detection of a damage is increased.

Further, it is possible to accurately predict attention portions of airframes for which usage environments are similar, and this accurate prediction leads to shorting of a downtime of the airframe by a preliminary prediction of timing of a future refurbishment of the airframe and specific sites of the airframe.

The category generation unit of the above position determination device may determine the usage environment information set, based on user information about a user operating the aircraft.

The aircrafts can be categorized further accurately by additionally taking into account that the usage environments of the airframes differ for each of users operating the aircrafts.

The determination unit of the above position determination device may determine, for each of the categories, the arrangement position of the measurement device, based on structural monitoring data having been obtained through previous operation of the aircraft in a state in which the measurement device is arranged at a predetermined position of an airframe of the corresponding aircraft.

By using structural monitoring data that is obtained through previous operation of the aircraft, influences exerted on the aircraft through its operation, and the frequency of influences having been exerted on the aircraft can be grasped, and thus, the setting of the arrangement position of the measurement device can be efficiently performed.

The determination unit of the above position determination device may determine the arrangement position of the measurement device, based on history information that is obtained, for each of the categories, from at least one of a previous inspection and a previous repair.

By tracing the history of inspections and the history of repairs for each of the categories, the trends of portions to be inspected and portions to be repaired in an aircraft corresponding to the each category can be grasped, and thus, the setting of the arrangement position of the measurement device can be efficiently performed.

The present invention provides a position determination system including a measurement device for structural health measurement values in an aircraft whose structural health status is to be diagnosed, and the position determination device having any one of the above-described configurations.

The present invention provides a position determination method for determining an arrangement position of a measurement device for structural health measurement values in an aircraft whose structural health status is to be diagnosed, the position determination device comprising: a category generation step of categorizing in a same category, aircrafts having respective similar usage environment information sets, each usage environment information set being determined based on an aircraft type of the respective aircraft and a flight condition of the respective aircraft and indicating a usage environment of an airframe of the respective aircraft, and categorizing usage environment information sets into a plurality of categories; an extraction step of extracting among the plurality of categories, a category into which the aircraft to be diagnosed is categorized; and a determination step of determining the arrangement position of the measurement device relative to the aircraft to be diagnosed, based on previous data that changes depending on the usage environment and that has been obtained when aircrafts has been operated under the usage environment categorized into the category.

In the above category generation step, the usage environment information set may be determined based on user information about a user operating the aircraft.

The present invention provides a position determination program for determining an arrangement position of a measurement device for structural health measurement values in an aircraft whose structural health status is to be diagnosed, the position determination device comprising: a category generation process of categorizing in a same category, aircrafts having respective similar usage environment information sets, each usage environment information set being determined based on an aircraft type of the respective aircraft and a flight condition of the respective aircraft and indicating a usage environment of an airframe of the respective aircraft, and categorizing usage environment information sets into a plurality of categories; an extraction process of extracting among the plurality of categories, a category into which the aircraft to be diagnosed is categorized; and a determination process of determining the arrangement position of the measurement device relative to the aircraft to be diagnosed, based on previous data that changes depending on the usage environment and that has been obtained when aircrafts has been operated under the usage environment categorized into the category.

In the above category generation processing, the usage environment information set may be determined based on user information about a user operating the aircraft.

The present invention brings about an advantageous effect that damages of an aircraft can be accurately detected using a worthwhile number of sensors (measurement devices).

### BRIEF DESCRIPTION OF DRAWINGS

FIG. 1 is a perspective view of an aircraft whose structural health status is diagnosed, according to the present invention.

FIG. 2 is a functional block diagram of a position determination system according to the present invention.

FIG. 3 is a diagram that describes the selection of a hotspot in an aircraft.

### BEST MODE FOR CARRYING OUT THE INVENTION

Hereinafter, an embodiment of a position determination device, a position determination system provided with it, and position determination method and program according to the present invention will be described with reference to the drawings.

In FIG. 1, there is illustrated a perspective view of an aircraft 1 whose structural health status is diagnosed. There is illustrated an example condition in which measurement devices 2 for obtaining structural health status measurement values are disposed in the aircraft 1. The measurement devices 2 are disposed at a plurality of portions of the aircraft 1, and each of the measurement devices 2 is coupled via a communication line 3. The communication line 3 is coupled to a position determination system 20, and information about a structural health measurement values having been obtained by the each measurement device 2 is configured to be output to the position determination system 20 via the communication line 3.

FIG. 2 illustrates a functional block diagram of the position determination system 20 according to the present embodiment. The position determination system 20 includes a position determination device 10 and a storage unit 18.

The position determination device 10 is, for example, a computer, and includes a CPU; ROM (Read Only Memory) for storing therein programs executed by the CPU, and the like; RAM (Random Access Memory) that functions as work areas at the execution of the individual programs; and the like. A procedure of a series of processing for implementing various functions described later is stored in a recording medium or the like in the form of programs (for example, a position determination program), and by allowing the CPU to read the programs into the RAM or the like, and execute processes/arithmetic processing on information, the various functions described later are implemented.

FIG. 2 illustrates a functional block diagram that mainly explicitly shows, among various functions provided in the position determination device 10, functions that are related to the determination of positions at which the measurement devices 2 for obtaining the structural health status measurement values are arranged. As illustrated in FIG. 2, the position determination device 10 includes a category generation unit 11, an interaction history unit 12, a hotspot extraction unit 13, an extraction unit 14, and a determination unit 15. The position determination device 10 is coupled to the storage unit 18 in such a way as to be capable of reading and writing information from/into the storage unit 18.

The category generation unit 11 categorizes in a same category, aircrafts 1 having respective similar usage environment information sets, each usage environment information set being determined based on an aircraft type of the respective aircraft 1 and a flight condition of the respective aircraft 1 and user information about users operating the aircrafts 1 and indicating a usage environment of an airframe of the respective aircraft 1, and categorizes usage environment information sets into a plurality of categories. The category generation unit 11 stores the usage environment information sets categorized into the categories into the storage unit 18 as reference information R (see FIG. 3)

The flight conditions of the aircrafts 1 include, for example, their flight routes, the numbers of takeoffs and landings (flight cycles) associated with the aircrafts 1, and the like. The user information about users operating the aircrafts 1 is information about airline companies, or the like.

The category generation unit 11 includes a decision unit 17 that decides whether or not usage environment information sets are similar to each other, based on predetermined rules stored in the storage unit 18.

Examples of the predetermined rules include a determination that is made as to whether or not model numbers that differentiate aircraft types are the same, or is made as to whether or not aircraft types are similar, based on model number ranges used for grouping model numbers. Further, a determination is made as to whether or not flight routes are the same, or is made as to whether or not sets of flight data are similar, based on flight route groups used for deciding that flight routes are similar. Further, a determination is made as to whether the numbers of takeoffs and landings are the same, or is made as to whether or not the numbers of takeoffs and landings are similar, based on value ranges associated with the numbers of takeoffs and landings and used for deciding that the numbers of takeoffs and landings are similar.

The interaction history unit 12 obtains an interaction history including records of periodic inspections having been made on each of the aircrafts 1, records of repairs having been made on the each aircraft 1, and the like, and stores the interaction history and a corresponding usage environment information set into the storage unit 18 as part of the reference information R in such a way that the interaction history and the corresponding usage environment information sets are associated with each other.

The hotspot extraction unit 13 extracts hotspot portions, namely, portions at each of which a structure such as an aircraft 1 is likely to be subjected to damages (damages may occur) because of fatigue and the like specific to a categorized category, based on structural monitoring data having been obtained when the flights of the aircraft 1 provided with the measurement devices 2 have been made, and a damage history having been generated as the result of the flights of the aircraft 1 (the damage history including the frequency of damages, the degrees of influences exerted on others by the damages, and the like). Further, the hotspot extraction unit 13 stores the extracted hotspot portions and corresponding usage environment information sets into the storage unit 18 as part of the reference information R, in such a way that the hotspot portions and the corresponding usage environment information sets are associated with each other.

The extraction unit 14 extracts a category which is among the plurality of categories and in which an aircraft to be diagnosed 1 is categorized.

The determination unit 15 determines the arrangement positions of the measurement devices 2 relative to the aircraft to be diagnosed 1, based on previous data having been obtained when one of the aircrafts 1 has been operated under a usage environment corresponding to the categorized category (the previous data changes for each of the usage environments). Specifically, the determination unit 15 extracts hotspot portions that is associated with a usage environment having been categorized into the extracted category, based on the reference information R stored in the storage unit 18. Further, the determination unit 15 determines the arrangement positions of the measurement devices 2 relative to the aircraft to be diagnosed 1 (sites of one of the aircrafts 1).

The determination unit 15 outputs the determined arrangement positions of the measurement devices 2 to an output device (omitted from illustration) including a display or the like.

Hereinafter, the operation of the position determination system 20 according to the present embodiment will be described using FIGS. 1 to 3.

The category generation unit 11 categorizes in a same category, aircrafts 1 having respective similar usage environment information sets, each usage environment information set being determined based on an aircraft type of the respective aircraft 1 and a flight condition of the respective aircraft 1 and user information about users operating the aircrafts 1 and indicating a usage environment of an airframe of the respective aircraft 1. The usage environment information set is categorized into a plurality of categories (category names) A, B, C, . . . . For example, in FIG. 3, for each of airline companies X, Y, and Z, a corresponding usage environment information set is stored into the storage unit 18 as part of the reference information R.

The interaction history unit 12 records an interaction history that includes the record of the result of a periodic inspection if the periodic inspection has been made on an aircraft 1, and that includes the record of a repair if the repair has been made on the aircraft 1, in such a way that the interaction history is associated with a corresponding usage environment information set included in the reference information R of the storage unit 18.

Further, the hotspot extraction unit 13 extracts hotspot portions specific to a categorized category, based on structural monitoring data having been obtained when the flights of a corresponding aircraft 1 provided with the measurement devices 2 have been made, and a damage history having been generated as the result of the flights of the aircraft 1 (the damage history including the frequency of damages, the degrees of influences exerted on others by the damages, and the like). The hotspot extraction unit 13 stores the extracted hotspot portions and corresponding usage environment information sets into the storage unit 18 as part of the reference information R in such a way that the extracted hotspot portions and the corresponding usage environment information sets are associated with each other.

The extraction unit 14 extracts a category which is among the plurality of categories and into which an aircraft to be diagnosed 1 is categorized. The arrangement positions of the measurement devices 2 relative to an aircraft to be diagnosed 1 are determined based on previous date having been obtained when one of the aircrafts 1 has been operated under a usage environment corresponding to the categorized category. The determined arrangement positions of the measurement devices 2 are output to an output device (omitted from illustration) including a display or the like.

A person in charge of the execution of inspection of the aircraft 1, or the like confirms the arrangement positions of the measurement devices 2 (the sites of the aircraft 1) having been presented by the output device, and arranges the measurement device 2 at corresponding actual positions of the aircraft 1.

For example, in FIG. 3, for “AIRFRAME CORRESPONDING TO CATEGORY A, OPERATED BY AIRLINE COMPANY X”, it is illustrated that sites indicated in an aircraft 1 denoted by Q1 are hotspot portions, and thus, the measurement devices 2 may be arranged at these sites (for example, a site 1 and a site 4). Further, for “AIRFRAME CORRESPONDING TO CATEGORY C, OPERATED BY AIRLINE COMPANY Y”, it is illustrated that sites indicated in an aircraft 1 denoted by Q2 are hotspot portions, and thus, the measurement devices 2 may be arranged at these sites (for example, a site 3 and a site 7).

As having been described above, according to the position determination device 10, the position determination system 20 provided with it, and position determination method and program according to the present embodiment,

based on the aircraft types of the aircrafts 1 and the flight conditions of the aircrafts 1 and user information about users operating the aircrafts 1, aircrafts 1 having respective similar usage environment information sets, indicating usage environments of the airframes of the respective aircrafts, are categorizing in a same category, usage environment information sets are categorized into a plurality of categories and among the plurality of categories, a category into which the aircraft 1 to be diagnosed is categorized is extracted. Based on previous data at the time when aircrafts have been previously operated under a usage environment corresponding to the categorized category, the arrangement positions of the measurement devices 2 relative to the aircraft to be diagnosed 1 are determined.

Since aircrafts 1 have similar attention portions (for example, portions likely to be subjected to influences, damaged portions, and/or the like) depending on the usage environments, the arrangement positions of the measurement devices is determined, for the aircraft 1 to be diagnosed, based on the previous data having been obtained under a usage environment categorized category. In this way, it is enough just to extract and monitor only portions at which influences, damages, and the like have occurred in the category, that is, it is enough just to determine the arrangement positions in such a way that the extracted portions are set as measurement targets, and thus, the measurement devices 2 are decreased, and the probability of the detection of a damage is increased.

Further, it is possible to accurately predict attention portions of each of airframes for which usage environments are similar, and this accurate prediction leads to shorting of a downtime of the airframe by a preliminary (pre-damage) prediction of a timing of a future refurbishment of the airframe and specific sites of the airframe. Further, field data that is effective for a next-generation aircraft development can be obtained.

Further, by using structural monitoring data that is obtained through previous operation of an airframe 1, influences exerted on the aircraft 1 through its operation, and the frequency of influences having been exerted on the aircraft can be grasped, and thus, the setting of the arrangement positions of the measurement devices 2 can be efficiently performed.

By tracing the history of inspections and the history of repairs for each of the categories, the trends of portions to be inspected and portions to be repaired in an aircraft 1 for each of the categories can be grasped, and thus, the setting of the arrangement positions of the measurement devices 2 can be efficiently performed.

Heretofore, the embodiment of the present invention has been described in detail with reference to the drawings, but the specific invention is not limited to this embodiment, and design changes and the like not departing from the scope of the present invention are also included.

### REFERENCE SIGNS LIST

1 aircraft

2 measurement device

10 position determination device

11 category generation unit

14 extraction unit

15 determination unit

1. A position determination device for determining an arrangement position of a measurement device for structural health measurement values in an aircraft whose structural health status is to be diagnosed, the position determination device comprising:
a category generation unit that categorizes in a same category, aircrafts having respective similar usage environment information sets, each usage environment information set being determined based on an aircraft type of the respective aircraft and a flight condition of the respective aircraft and indicating a usage environment of an airframe of the respective aircraft, and categorizes usage environment information sets into a plurality of categories;
an extraction unit that extracts among the plurality of categories, a category into which the aircraft to be diagnosed is categorized; and
a determination unit that determines the arrangement position of the measurement device relative to the aircraft to be diagnosed, based on previous data that changes depending on the usage environment and that has been obtained when aircrafts has been operated under the usage environment categorized into the category.

2. The position determination device according to claim 1, wherein the category generation unit determines the usage environment information set, based on user information about a user operating the aircraft.

3. The position determination device according to claim 1, wherein the determination unit determines, for each of the categories, the arrangement position of the measurement device, based on structural monitoring data having been obtained through previous operation of the aircraft in a state in which the measurement device is arranged at a predetermined position of the airframe of the aircraft.

4. The position determination device according to claim 1, wherein the determination unit determines the arrangement position of the measurement device, based on history information that is obtained, for each of the categories, from at least one of a previous inspection and a previous repair.

5. A position determination system comprising:
a measurement device for structural health measurement values in an aircraft whose structural health status is to be diagnosed; and
the position determination device according to claim 1.

6. A position determination method for determining an arrangement position of a measurement device for structural health measurement values in an aircraft whose structural health status is to be diagnosed, the position determination device comprising:
a category generation step of categorizing in a same category, aircrafts having respective similar usage environment information sets, each usage environment information set being determined based on an aircraft type of the respective aircraft and a flight condition of the respective aircraft and indicating a usage environment of an airframe of the respective aircraft, and categorizing usage environment information sets into a plurality of categories;
an extraction step of extracting among the plurality of categories, a category into which the aircraft to be diagnosed is categorized; and
a determination step of determining the arrangement position of the measurement device relative to the aircraft to be diagnosed, based on previous data that changes depending on the usage environment and that has been obtained when aircrafts has been operated under the usage environment categorized into the category.

7. The position determination method according to claim 6, wherein, in the category generation step, the usage environment information set is determined based on user information about a user operating the aircraft.

8. A position determination program for determining an arrangement position of a measurement device for structural health measurement values in an aircraft whose structural health status is to be diagnosed, the position determination device comprising:
a category generation process of categorizing in a same category, aircrafts having respective similar usage environment information sets, each usage environment information set being determined based on an aircraft type of the respective aircraft and a flight condition of the respective aircraft and indicating a usage environment of an airframe of the respective aircraft, and categorizing usage environment information sets into a plurality of categories;
an extraction process of extracting among the plurality of categories, a category into which the aircraft to be diagnosed is categorized; and
a determination process of determining the arrangement position of the measurement device relative to the aircraft to be diagnosed, based on previous data that changes depending on the usage environment and that has been obtained when aircrafts has been operated under the usage environment categorized into the category.

9. The position determination program according to claim 8, wherein, in the category generation processing, the usage environment information set is determined based on user information about a user operating the aircraft.
